(19) United States
(12) Patent Application Publication
(10) Pub. No.: US 2008/0095888 A1
(43) Pub. Date: Apr. 24, 2008

(54) Nutritional Ingredient Containing Bioavailable Mineral Nutrients

(76) Inventors: Grant Vandenberg, Saint-Augustin-de-Desmaures (CA); Xavier De Rouvroy De Saint Simon, Sainte-Foy (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/659,288

(22) PCT Filed: Aug. 1, 2005
(86) PCT No.: PCT/CA05/01199

§ 371 Date: Feb. 2, 2007

Related U.S. Application Data
(60) Provisional application No. 60/592,376, filed on Aug. 2, 2004.

(51) Int. Cl. A23L 1/28; A23L 1/48

(52) U.S. Cl. 426/62; 426/61

(57) ABSTRACT

The present invention relates to a nutritional ingredient, a composition comprising said ingredient and a method of making such an ingredient. The nutritional ingredient is exposed to at least one type of microorganism to render mineral nutrients contained therein bioavailable for absorption in the digestive tracts of animals or humans or both. This increases the solubility of the mineral nutrients which in the case of animals feeds lessens the mineral waste, in particular phosphates which can negatively impact the environment.

### BACKGROUND OF THE INVENTION

The present invention relates to a nutritional ingredient for oral administration to humans or animals or both comprising bioavailable mineral nutrients. Also, the invention relates to methods of preparing such ingredients whereby the nutritional ingredient is treated with at least one type of microorganism so as to render the mineral ingredients bioavailable and absorbable by the digestive tracts of humans or animals or both.

By far the major source of phosphate is from dietary foods, such as milk and milk products, which are also major sources of calcium, but phosphate is also present in many other dietary foods, including especially meats and—vegetable sources.

Minerals are often poorly absorbed from the intestinal tract because of the relative insolubility of many of such compounds and also because bivalent cations are poorly absorbed through the intestinal mucosa. On the other hand, for example, phosphate is absorbed exceedingly well most of the time except when excess calcium is present; the calcium tends to form almost insoluble calcium phosphate compounds in the intestines that fail to be absorbed but instead pass on through the bowels to be excreted in the feces. In-mammals for example, about seven eighths of the daily intake of calcium is not absorbed and therefore is excreted in the feces, the remaining one eighth is eventually excreted in the urine.

1,25-dihydroxycholcalciferol has long been studied for its numerous effects on the intestinal epithelium to promote intestinal absorption of minerals, and more particularly calcium, and indirectly phosphate. Probably the most important of these effects is that it causes the formation of a mineral-binding protein in the intestinal epithelial cells. The rate of mineral absorption seems to be directly proportional to the quantity of this mineral-binding protein. Furthermore, this protein remains in the cells for several weeks after the 1,25-dihydroxycholcalciferol has been removed from the body, thus causing a prolonged effect on calcium absorption. Other effects of 1,25-dihydroxycholcalciferol that might play a role in promoting calcium absorption are (1) the formation of a calcium-stimulated ATPase in the brush border of the epithelial cells and (2) the formation of an alkaline phosphatase in the epithelial cells. Unfortunately, administration of 1,25-dihydroxycholcalciferol is still controversial because of its undesired physiological effects.

In addition, in cow's milk and yogurt, a water-soluble inorganic acid form or organic acid form of calcium, such as calcium lactate and calcium chloride, water-difficulty soluble inorganic form of calcium, such as calcium carbonate and calcium phosphate are used.

However, the water-soluble inorganic acid form or organic acid form minerals are liable to damage the stability of proteins contained in—cow's milk and yogurt and thus they have a disadvantage that it is difficult to add more than the level that does damage the stability of proteins.

On the other hand, the water-insoluble mineral in an inorganic form does not damage the stability of proteins contained in food due to water-insolubility and thus it can be used in a large amount. A selected mineral in an inorganic form generally has, however, a high specific gravity and thus when said selected mineral is dispersed in the food, mostly in liquid foods, it precipitates in a short time to undesirably lower its bioavailability. As a result, it has a disadvantage that it cannot be used in any way in a large amount.

The availability of dietary P ultimately depends on its form and origin; that from mineral and animal sources shares common constraints, whereas P from plant-protein ingredients has distinct characteristics affecting P bioavailability. Phosphorus from mineral and animal origin is generally inorganic, and its bioavailability for terrestrial monogastrics is largely related to its solubility.

Phosphorus present in many fish feeding pellets usually originates from added crushed bones to the recipe formulation and residual mineral matter. Inorganic P (Pi) is usually chemically associated with calcium ions forming mono-, di-, and tribasic Phosphates (CaPO₄, Ca₂(PO₄)₂, Ca₃(PO₄)₃). Another animal Ca and P component present in feed ingredients is hydroxyapatite (Ca₅(PO₄)₅—X). Hydroxyapatite mostly originates from bone structures. The monobasic and dibasic forms are easily bio-available to the fish, but represent a small portion of the inorganic phosphorus present in for example, fishmeal, a widely used feed ingredient.

It is known that soil fungus and bacteria, in association with plant roots (rhizosphere) have developed mechanisms to solubilize inorganic phosphorus and make it available for the plant. This unique ability of micro-organisms has been used in the agriculture industry to enhance ground Pi uptake by plants.

A range of soil micro-organisms able to solubilize precipitated forms of P or mineralized inorganic P has been characterized (Whitelaw, 2000, Advances in Agronomy, 69:99-151). Typically, such organisms have been isolated using cultural procedures, with species of Pseudomonas and Bacillus bacteria and Aspergillus and Penicillium fungi being predominant (Kucey et al., 1989, Advances in Agronomy, 42:199-228; Rodríguez and Fraga, 1999, Biotechnology Advnces 17:319-339; Whitelaw, 2000, Advances in Agronomy, 69:99-151). Despite this, there are few examples of the successful application of microbial inoculants. Essentially, a lack of consistent performance under different environmental conditions in the field has precluded their wider use.

Nevertheless, some micro-organisms show consistent plant growth promotion under greenhouse and field conditions and have been developed as commercial inoculants (eg., Penicillium spp., Leggett et al., 2001, In: Ae N, Arihara J, Okada K, and Srinivasan A (Eds). Plant Nutrient Acquisition: New Perspectives. Saskatchewan 520 p.). The common mechanism used by these micro-organisms to solubilize Pi and using it is by producing organic acids (formic, glucuronic, acetic, lactic, oxalic, etc.) that break down hydroxyapatite minerals into mono- or dibasic phosphates. These more soluble forms of Pi are therefore more available for plant roots.

Many methods for adding a large amount of minerals to foods have been heretofore proposed. The mineral elements, include phosphorus and the so-called micro-nutrients or other minerals (e.g. copper, iron and zinc), but many foods are deficient in such elements or they contain them only in forms which cannot be readily taken up by humans or animals or both (it is generally believed that essential elements cannot be readily taken up unless they are present in dissolved form in the food).

To counteract such deficiencies, sources of the deficient elements are commonly added to foods in order to improve growth rates and yields obtained from animal herds. For example, phosphates are often added to food to counteract a lack of phosphorus. Large deposits of rock phosphates are available in many locations, but untreated rock phosphates have low water (citric acid) solubility, particularly in neutral or alkaline food systems, and consequently do not provide an easily-assimilable source of phosphorus. In order to overcome this problem, rock phosphates are usually chemically converted to more soluble compounds (e.g. mono-ammonium phosphate or triple-super-phosphate) in large-scale food or food input-manufacturing facilities. However, such conversions suffer from the disadvantages that they are relatively expensive and the conversion facilities may not be conveniently located close to animal-herds, or fishery areas.

Accordingly, there is still a need for an improved system for increasing the levels of available minerals such as phosphorus and/or micro-nutrients in feeding compositions.

### SUMMARY OF THE INVENTION

The present invention provides a nutritional ingredient which can be administered orally to humans or animals or both. The nutritional ingredient provides one or more mineral nutrients in bioavailable form that are absorbable by the digestive tracts of humans or animals or both. The nutritional ingredient is treated with at least one type of microorganism so as to render the one or more mineral nutrients bioavailable and absorbable by the digestive tracts of humans or animals or both. The mineral nutrients may be for example, but not limited to, phosphorus, calcium, or salts or derivatives thereof. Other mineral elements or nutriments (nutrients) form part of the present invention, such as, but not limited to, copper, manganese, iron, molybdenum, potassium, zinc, selenium, chromium, fluoride, iodine, magnesium, or salts or derivatives thereof.

In one aspect of the invention the treatment with the at least one type of microorganism may be at a concentration of at least 0.1 mg/l for a period of time required to render the mineral nutrients bioavailable.

The nutritional ingredient may be formulated into any suitable food composition for oral administration, the formulations for which are well known to those skilled in the art. The compositions may be selected from food supplements, nutritional supplements, food compositions, as well as animal feeds and fish feeds in particular.

The microorganism can be selected from the group consisting of a fungus, a bacteria, or a yeast. The fungus may be of the genus Penicillium, in particular, it may be the fungus is Penicillium bilaii.

The nutritional ingredient may comprise inorganic as well as organic mineral nutrients.

In another aspect, the present invention provides a method for treating a nutritional ingredient or composition containing such a nutritional ingredient to render mineral nutrients contained therein bioavailable, comprising subjecting the nutritional ingredient comprising mineral nutrients or a composition containing it, to exposure to at least one type of microorganism to render the mineral nutrients bioavailable and absorbable in the digestive tracts of animals or humans or both.

It is possible for the nutritional ingredient to be incorporated already into a composition or formulation such as a nutritional supplement, food supplement or food composition before being subjected to this treatment.

The processing with the at least one type of microorganism is generally for a period of time sufficient to cause the mineral nutrients to become absorbable in the digestive tract of a human or animal or both. The mineral nutrients can be added to the ingredient or the composition or formulation, for example an inorganic mineral or they can be naturally occurring in the nutritional ingredient or composition.

The microorganism can be selected from the group consisting of a fungi, a bacteria, or a yeast. The fungus of the genus Penicillium has proven to be effective, with the fungus Penicillium bilaii being particularly effective.

For the purpose of the present invention the following terms are defined below.

The term “nutritional ingredient” encompasses a component which provides mineral nutrients in an orally administrable form for an animal or human or both. The mineral nutrients may be inherently present in the ingredient and/or they may be added to it. The ingredient may comprise a combination of materials or substances. For example in the case of fish feed, Menhaden represents a typical example of an ingredient that provides nutrient minerals in fish pellets.

The term “food-compatible” as used herein is intended to mean any material which can be added to the food without having an adverse effect on human or animal or both health, food structure, food quality, or the like.

By “input” of a particular element it is meant a compound of that element which, at least in the food or food input conditions under consideration, does not make the element fully available for human or animal or both uptake.

The terms “absorbability” or “absorption” as used herein are intended to mean the rate at which and the process by which molecules and atoms from the environment enter the interior of the organism via passage across (or around) the lining cells of the gastro-intestinal tract. For the purpose of the present invention, these terms are preferably, but not limitatively, use to mean availability at the digestive tract level from the lumen. Absorption can occur all the way from the stomach to the rectum, although the small intestine is the organ most importantly involved in absorption. Absorptive efficiency for many nutrients, notablyphosphate, iron, calcium and zinc, is governed by homeostatic feedback regulation. When the body stores are too low, the intestine up-regulates the avidity with which the intestine takes up the nutrient. When the body reserves are adequate or increased, the gut down-regulates the nutrient's uptake. At a molecular level, this regulation can be expressed by the control of intraluminal binding ligands, cell surface receptors, intracellular carrier proteins, intracellular storage proteins, or the energetics of the transmembrane transport.

The term “bioavailability as used herein refers to the extent to which a nutrient reaches its site of pharmacologic or physiological action. For practical purposes, this definition includes the extent to which the nutrient reaches a fluid, such as, but not limited to, the blood, that bathes the site of action and via which the nutrient can readily reach the site of action. The bioavailability of a mineral depends directly on the extent to which the mineral is absorbed and distributed to the site of action and depends inversely on the extent to which it is metabolized and excreted prior to arriving at the site of action. The bioavailabitlity of a mineral in the context of the present invention includes the trasformation of a mineral, or a compound or composition containing minerals, from a not absorbable form into a form absorbable by the digestive tract or the gut of a human or an animal. The vast bulk of mineral absorption occurs in the small intestine. The best-studied mechanisms of absorption are clearly for calcium and iron, deficiencies of which are significant health problems throughout the world. Intestinal absorption is a key regulatory step in mineral homeostasis. Mineral homeostasis is the body's physiologic efficiency in absorbing the level of minerals the body requires from those minerals that are available to it.

Active transport of minerals is an important mechanism of homeostatic control. The minerals in foods are normally present at low concentrations. Active transport mechanisms have evolved to ensure their absorption. In general, there is an inverse relationship between mineral availability and absorption. Active transport of minerals increases in response to a mineral deficiency or decreases if a mineral is in excess. Thus, the more of an actively transported nutrient is supplied, the less that is absorbed. For example, feeding a diet low in phosphorus or calcium results in an increase in intestinal phosphorus or calcium absorption. This adaptive mechanism can be caused by a PTH-mediated stimulation of 1,25-dihydroxyvitamin D synthesis, the active vitamin D metabolite that increases the rate of transcellular active calcium transport in the intestine. Hence, the form into which a mineral is a key point of its bioavailability and absorbability at the intestine level. The present invention provides a new compound, composition and method for improving these physiological aspects of bioavailability and absorbability or minerals.

### BRIEF DESCRIPTION OF THE DRAWINGS

FIG. 1 illustrates in vitro Pi availability after 20 days exposition to P bilaii; and

FIG. 2 illustrates the influence of P. bilaij supplementation in different culture media in in vitro P availability over time.

### DESCRIPTION OF THE PREFERRED EMBODIMENT

The present invention now will be described more fully hereinafter with reference to the accompanying drawings, in which embodiments of the invention are shown. This invention, may, however, be embodied in many different forms and should not be construed as limited to the embodiments set forth herein; rather, these embodiments are provided so that this disclosure will be thorough and complete, and will fully convey the scope of the invention to those skilled in the art.

In accordance with the present invention, there is provided a composition in which minerals are available as food micro-nutrients by submitting—the ingredient or composition, containing it or a food input to fermentation or micro-organism culture.

In one embodiment of the present invention, micro-organisms are used as a means to improve inorganic P bio-availability in human or animal or both diets. This can be translated into a lower P input in farms and aquatic animals through feeds and in a more available form for meeting human—or animal or both needs.

Also, the present invention helps to lower the P outputs thus resulting in greater profitability for farming and aquaculture facilities, and constitutes an upstream approach to treating environmental problems related to excessive P output.

The present invention is based on the finding that micro-organisms, particularly fungi, more particularly fungi of the genus Penicillium, not only have a very good ability to improve the availability of minerals, as for example but not limited to, phosphorus both from insoluble phosphates and from manufactured foods or food inputs and that it can also improve the availability of micronutrients such as calcium, copper, manganese, iron, molybdenum, potassium, zinc, selenium, chromium, fluoride, iodine, magnesium, or salts or derivatives thereof., but also that the micro-organism propagates readily and remains viable when applied to foods or food inputs and so can be used without difficulty as a food amendment.

The fungi can be applied to foods which already contain insoluble phosphates or micronutrients, or it can be applied in conjunction with untreated sources, or rock phosphates or manufactured foods. It will be recognized from one embodiment of the present invention that the micro-organism can be in vegetative form, such as spores, or other active forms.

Thus, according to another aspect, the invention provides a method of increasing the availability of or rendering available minerals and/or micronutrients for humans or animals or both uptake from food, which method comprises introducing into the food or food input or ingredient, an inoculum of a desired micro-organism to release for human or animal or both uptake the minerals and/or micronutrients from a source thereof originally present in the food or added thereto as an amendment.

The micro-organisms can be easily propagated on different suitable mineral sources. Propagation normally takes place for a determined period of time and generally is conducted until bioavailability of the minerals is achieved. The resulting micro-organism propagated on a solid support may be used as such for incorporation into the food, alternatively on a food input, but may be coated onto the foods if desired. Alternatively, a liquid culture of the micro-organisms may be prepared by using a conventional nutrient solution. The liquid culture may then be used as such or dried and the dried product applied to the food either with or without a suitable mineral and/or nutrient source.

Also, it will be recognized by someone skilled in the art that for example, starch, sucrose, glucose, cellulose and mixtures thereof can be suitable carriers for fungal spores. These materials make it easy to handle the spores and also act as carbon sources for the spores.

The spores can simply be mixed with the carrier (e.g. a 50:50 by weight mixture of soluble starch and cellulose) and then the spore content can be adjusted, if desired, by the addition of further carrier.

The spore/carrier mixture can be added to an input of the food or can be used to coat inputs prior to manufacturing foods.

The amount of the inoculum to be applied to the food or food input or food ingredient is not limited in any particular respect. Clearly, if insufficient inoculum is used, a noticeable effect will not be obtained. On the other hand, the use of large amounts of the inoculum will be wasteful because the amounts of minerals and/or micronutrients made available in the food reach a maximum at a certain application rate and further additions beyond this rate do not give additional benefits. The suitable application rates vary according to the type of food or food input, the type of animals, the amounts of the source of phosphorus and/or micronutrients present in the food or added thereto, etc. and a suitable rate can be found without difficulty by simple trial and experiment for each particular case.

Since the micro-organism has the effect of solubilizing minerals and micronutrients which may already be present in food or food input (i.e. those which are native to the food) and also those which are added to the food, the micro-organism may be applied alone to foods which contain native sources of minerals and/or micronutrients, or may be applied to any foods in conjunction with added sources of minerals and/or micronutrients.

Untreated sources of a mineral are not only sources of the mineral, but also usually contain other micronutrients (e.g. copper, iron and zinc). Accordingly, the use of micro-organisms in conjunction with added or native, such as, but not limited to, rock phosphate, forms a particular aspect of the invention because both minerals and micronutrients are made available for plant uptake in this way. Manufactured foods often contain such sources and so the double benefit of the invention is also obtained when these foods are used with the micro-organisms. If the mineral source does not contain the micronutrients, sparingly soluble sources of these elements may be added to the food with the micro-organism. However, other sources of minerals which occur naturally in food input or are added thereto may be used. Any mineral source can be microbiologically treated for the purpose of the present invention. The mineral source can be even non physiologically compatible with a human or an animal body, but can provide minerals that are physiologically compatibles after microbiological treatment. In the production of a food compound according the present invention, the mineral source can be as well a mineral source, such as, but not limited to, a piece of rock or heart, as a vegetable or an animal originating source, such as a bone derivative, such as bone meal.

As noted above, it has surprisingly been found that the micro-organisms, such as fungi, increase the amount of phosphorus available for human or animal or both uptake from commercial mineral foods, thus reducing the amounts of these foods required, so commercial food inputs can be added to the food instead of, or even as well as, natural rough pieces of, for example phosphate, or other minerals.

It is considered that a micro-organism increases the amount of mineral available for human or animal or both uptake from commercial mineral foods because these foods are acted upon by food components in such a way as to convert a certain proportion of the mineral into insoluble mineral compounds and this proportion is then solubilized by the action of the micro-organism and hence does not go to waste.

Commercially available food minerals can be of many types. For example, some common derivatives of phosphate are those containing monoammonium phosphate (MAP), triple super phosphate (TSP), diammonium phosphate, ordinary superphosphate and ammonium polyphosphate. All of these products are produced by chemical processing of insoluble natural rock phosphates in large scale manufacturing facilities and, as noted above, the product is expensive.

By means of the present invention, at least in its specific forms, it is possible to reduce the amount of these minerals applied to foods or food input by up to 50% or more while still maintaining the same amount of phosphorus uptake from the food. When rough pieces of mineral are used as the source of mineral and/or micronutrients, the supported micro-organism may be mixed with the rough pieces and the resulting mixture introduced into the food, or alternatively the micro-organism may be added to the food or food input separately from the pieces of minerals.

Preferably, a carbon source for microbial growth is applied to or may be naturally occurring in the food or food input in addition to the mineral. This carbon source may be additional to the one used for the initial propagation of the micro-organisms, i.e. the one forming part of the inoculum. The additional carbon source often increases the nutrient uptake of humans or animals fed with the treated food, presumably because of increased microbial growth rates.

It has been found that the presence of a small amount of nitrogen (introduced in the form of the ammonium ion) improves the mineral solubilisation by micro-organisms, such as, but not limited to, Penicillium. For this reason NH₄Cl or another ammonium source is preferably applied to the food or food input at approximately the same time as, or in admixture with, the micro-organism. The amount of the ammonium source added normally falls within a range depending on the microbial species. When a manufactured input of, such as MAP, is added to the food, the ammonium need not be added because it is already a component of the food.

In accordance with another embodiment of the present invention, there is provided a composition for improving the bioavailability and absorbability of a mineral, comprising a food compound microbiologically treated as described herein, with a food, pharmaceutical, or nutraceutical substrate, or a carrier. It will be recognized that the microbiologically treated food compound can be administered to a human or an animal separately from or in the same time to the other substances. For example, in the field of fish production, a fish meal, can be used as carrier. It can be mixed to any Dried whey other product, such as, but not limited to, soybean meal, corn gluten meal, wheat middings animal or vegetable oil, vitamins and other minerals.

As illustrated in the following examples, the growth of fish has been found to be improved in several ways including faster growth rates of individual juvenile fish, the survival and growth of a larger percent of hatched fish, and the production of more fish per unit of aquatic environment area.

In one particular embodiment of the present invention, the treated food composition allowing higher availability of minerals can be administered or introduced into the regime or different species of animals, including human, such as mammalians or birds.

According to another embodiment of the present invention, there is provided a composition comprising a food compound microbiologically treated to render minerals bioavailables and absorbable by human and animal gut and intestine, with a food substrate. The food substrate is preferably a food composition ready for serving, but it can be also a compound, liquid or solid, with desired consistency or viscosity, that has to be processed before serving. The food substrate can be alternatively used in the context of a nutraceutical or pharmaceutical application. It is admitted here that a food compound microbiologically treated as described herein, can be orally administered in order to obtain a pharmaceutical effect, in a pharmaceutical context.

To effectively supply food for fish, and provide for their growth in an aquatic environment, the water can be allowed to be in contact with the selected phosphate compounds for a period of time amounting to between 30 and 365 days to disseminate water soluble nutrients that can be slowly released.

The use of a microbiologically treated nutritional ingredient as described herein for improving the mineral physiological availability and absorbability is also effective when the mineral compound chosen is a complex form. For example, but not limited to, the mineral can be one of the following compounds: magnesium ammonium phosphate, magnesium potassium phosphate, manganese ammonium phosphate, manganese potassium phosphate, zinc ammonium phosphate, zinc potassium phosphate, ferrous ammonium phosphate, and ferrous potassium phosphate. Once again, phosphate is illustrated here but it will be recognized by the person skilled in the art that other minerals, such as calcium, copper, manganese, iron, molybdenum, potassium, zinc, selenium, chromium, fluoride, iodine, magnesium, can be used in a complex form also.

Another embodiment of the present invention is to provide a method for rendering a mineral bioavailable and absorbable by the digestive tract, the gut or the intestine of a human of an animal, by microbiologically treating a food compound. Preferably, the food compound is treated with placing it in culture, or in culture conditions allowing the growth of the microorganism on it. The microorganism in used at a concentration of at least 0.1 mg/l. However, it will be understood) from the present invention that the microorganism can be at a concentration that will give a desired bioavailability, and depending on the group to which it pertains, such as bacteria, fungi, yeast, or mold. The duration of treatment also depends on the level of bioavailability desired, the microorganism used and the culture conditions. For example, a fungus can be culture at a concentration of between 5 to 500 mg/l (or mg/kg) of culture, and kept on the food compound to be treated for a period of 12 hours to 60 days or more.

The present invention will be more readily understood by referring to the following examples which are given to illustrate the invention rather than to limit its scope.

### Example I

### In Vitro Assays

Materials and Methods

Method for assessing Total P concentrations

A standard spectrophotometric method was adapted for total P using a Technicon™ autosampler (Varley 1966, Analyst, 91:123-126).

In Vitro Method for Assessing Pi Bioavailability or Solubilisation

An in vitro method using neutral ammonium citrate (2%) Pi solubilisation as a way to determine Pi bioavailability was used. This method allows the determination of factors affecting the ability of microbes to solubilize P. In vivo studies permit the evaluation of such in vitro tests to assess Pi bioavailability in the treated fishmeal.

In Vivo Method for Assessing P Bioavailability in a Standard Diet

The microbe-treated fishmeal, for which the composition is described in Table 1, was incorporated in a reference diet and Pi digestibility was measured by recuperating feces, measuring their P concentrations. For digestibility measurement purpose, Sipernat™ (source of acid insoluble ash (AIA) external marker) was added and allows through the measurement of insoluble ash (Atkinson J L et al., 1984, Canadian J. Fish. And Aquatic Sci. 41:1384-1386) measurement of digestibility. To measure the nutrient digestibility of an individual ingredient, 30% of the reference diet was replaced with treated fish meal, and standard calculations used for each nutrient (Cho et al., 1982, Comparative Biochem. Physiol. Biochemistry and Mol. Biol., 73:25-41).

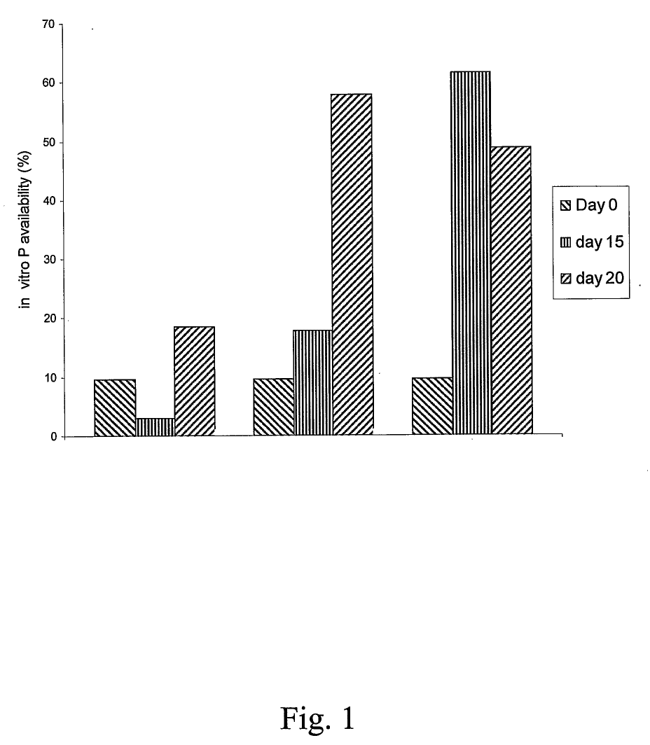

FIG. 1 shows the in vitro availability of phosphate at days 0, 15 and 20 of treatment with microbe-treated fishmeal.

TABLE 1
Composition of diet with Menhaden fish meal.

| Ingredients | Inclusion (%) |
|---|---|
| Fish meal (menhaden) | 29.40 |
| Soybean meal | 12.74 |
| Corn gluten meal | 16.66 |
| Wheat middings | 16.17 |
| Dried whey | 9.8 |
| Fish oil | 11.27 |
| Vitamin | 0.98 |
| Mineral | 0.98 |
| Sipernat ™ | 1.96 |

### Example II

### Exposition of Fish Meal to Microorganisms

Experimental Design

Microbiological processes: Penicilium bilaii was cultured in a 0.3 L bio-reactor.

All media were sterilised to eliminate endogenous biomass. Two media (potato-dextrose broth, yeast extract-dextrose) were inoculated with either 10 or 20 mg spores/l, and added to the Menhaden meal. More details are given in Table 2. A control medium containing no spores was added to the menhaden meal as above. Each medium had a controlled air flow (all identical) to ensure an aerobic environment. On a daily basis, the fish meal was humidified with sterile nutrient broth by spraying with a fine mist with concomitant mixing to ensure homogenous dispersion. After each inoculation or nutrient addition, a mixing action using a grinder was carried out with the control mixed first to avoid any kind of contamination. The grinder was then decontaminated using sodium chloride and soap. The incubations were allowed to proceed for 20 days at room temperature; sub-samples were taken at 10, 15 and 20 d for evaluation of nutrient digestibility.

TABLE 2
Composition of fish meal (menhaden) included in diet.

| Treatments | Descriptions |
|---|---|
| MEN | Basic fish feed including 30% of menhaden fish meal |
| CTL | 30% of MEN replaced by menhaden fish meal treated |
| | without P. bilaii |
| T1 | 30% of MEN replaced by menhaden fish meal treated with |
| | 10 mg/L of spores P. bilaii |
| T2 | 30% of MEN replaced by menhaden fish meal treated with |
| | 20 mg/L of spores P. bilaii |

P. bilaii was cultivated in a 0.3 L bio-reactor, enhancing P availability in vitro.

Results

The control medium showed a lower Pi bioavailability than the one from our other media. It had a range of 10 to 20% bioavailability.

We can see mycelium developments on the surface (Menhaden fish meal) looking morphologically alike the P bilaii colonies we identified in our preliminary experiments Supplementation of fishmeal with both levels of spores results in significant increase in phosphorus digestibility in vitro and in vivo at both levels of P. bilaij supplementation. Inclusion of the microbe at 20 mg/l medium resulted in a more rapid increase in in vitro P availability had its bioavailability enhanced 6 times more than the original menhaden.

Each inoculated medium had a greater Pi bioavailability than the control. These experiments now demonstrate that P. bilaii is responsible for most of the Pi solubilisation. The bioreactor approach lets us measure the Pi solubilizing capacity of this peculiar micro-organism. By paying attention to the scale effects of an industrial approach, such a process can be developed to produce a large portion of bioavailable inorganic phosphorus included in fish feeds. This approach may be also used on feed ingredients other than fishmeal rich in unavailable Pi.

### Example III

### Incorporation of Microbe-Treated Fish Meal in a Standard Diet

Experimental Design

A standard reference diet was formulated according to Table 1. After that 70% of this fish feed was mixed with 30% of the treated (10 mg/L of spores and 20 mg/L of spores) or un-treated fish meal. Digestibility studies were undertaken over an 11-day period with 4 days of diet adaptation and 7 days of feces collection.

Feed and feces were analyzed for dry matter, ash and phosphorus levels according to standard methods. Values of apparent digestibility coefficient of fish feed (ADC) and fish meal (ADCT) was calculated for each diet (Cho C Y et al., 1982, Comp. Biochem. And Physio. Biochem. And Mol. Biol., 73:25-41).

When the digestibility was calculated according to the test ingredients, differences in digestibility were observed for dry matter, ash and phosphorus. Table 3 illustrates that the digestibility coefficients increase with the amount of spores in the treatment of Menhaden fish meal.

TABLE 3
Digestibility coefficient of Menhaden fish meal (ADC_{T}).

| | Dry Matter (%) | Ash (%) | Phosphorus (%) |
|---|---|---|---|
| Control | 64.8 | 13.9 | 30.3 |
| 10 mg/L spores | 77.6 | 30.1 | 38.3 |
| 20 mg/L spores | 83.5 | 46.4 | 58.9 |

When the results were compared for availability and digestibility, significant differences between treatments were obtained. The diet with 20 mg/L of spores had the higher digestibility values, in particular for phosphorus. Total mineral digestibility as indicated by ash digestibility as well as dry matter digestibility, also increased with increasing level of P. bilaii concentration. In conclusion, incorporating menhaden fish meal previously treated with Penicillium bilaii spores, in fish feed will increase significantly the digestibility of phosphorus, dry matter and total minerals. Table 3 shows that ash digestibility (indicating overall mineral digestibility) is increased.

### Example IV

### Assessment of Inorganic Phosphate Solubilisation from Different Sources

The aim of this experiment was to measure the solubilisation of phosphate in vitro following the treatment with Penicillium bilaii of different carbon sources, such as starch, glucose, sucrose, and chitosan.

Materials and Methods

Treatment Conditions

CTL: Base culture medium

HA-A: P. bilaii in base medium comprising hydroxyapatite and starch

HA-G: P. bilaii in base medium comprising hydroxyapatite and glucose

HA-S: P. bilaii in base medium comprising hydroxyapatite and sucrose

HA-C: P. bilaii in base medium comprising hydroxyapatite and chitosan

Os-A: P. bilaii in base medium comprising bone flour and starch

Os-G: P. bilaii in base medium comprising bone flour and glucose

Os-S: P. bilaii in base medium comprising bone flour and sucrose

Os-C: P. bilaii in base medium comprising bone flour and chitosan

Composition of Base Medium

In 1 L Distilled Water, Add:

| | | | |
|---|---|---|---|
| 0.4 | g | NH₄Cl (ammonium) | FW 63.49 |
| 0.78 | g | KNO₃ (nitrate) | FW 101.1 |
| 0.1 | g | NaCl | FW 58.44 |
| 0.5 | g | MgSO₄•7H₂O | FW 246.5 |
| 0.1 | g | CaCl₂•2H₂O | FW 147.0 |
| 0.5 | mg | FeSO₄•7H₂O | FW 278.02 |
| 1.56 | mg | MnSO₄•H₂O | FW 169.0 |
| 1.40 | mg | ZnSO₄•7H₂O | FW 287.6 |
| 2 | μg | Vitamin B₁₂ | FW 1355 |

Supplementary Nutrients

30 mM inorganic phosphate source:

| | |
|---|---|
| 1. HA (Ca₅HO₁₃P₃) | FW 502.3 |
| 2. Bone meal (2.1% P) | |

30 g/L carbon source:

| | |
|---|---|
| 1. sucrose | FW 342.3 |
| 2. glucose | FW 180.2 |
| 3. starch | |
| 4. chitosan | |

Results
Visual observations
CTL: No changes
HA-A: No changes
HA-C: No changes
HA-G: J5: Growth of small white and yellow colonies
   J10: Diffuse growth
   J17: Numerous bright yellow flocks
HA-S: Apparent growth
Os-A: J5: filaments
   J10: filaments
   J17: strong filaments
Os-C: J5: surface filaments
   J10: filaments
   J17: large surface skin and micro-particles
Os-G: J5: big flocks
   J10: filaments
   J17: large surface skin and micro-particles
Os-S: J5: big flocks
   J10: filaments
   J17: large surface skin and micro-particles

A first repeat of the—experiment described in Example IV was performed, but using sucrose and glucose only as carbon sources. The results were as follows:

Visual Observations in the Repeat;

CTL: No changes
HA-G Pb: J10: white colonies with peach colored central area
   J20: High growth, with white, green yellow and red colonies, brown-yellow liquid
   J31 idem J20
HA-G: J10: No changes
   J20: Filament at the bottom
   J31: Small cloud colonies, skin layer
HA-S Pb: J10: No changes
   J20: No changings
   J31: Small cloud colonies, skin layer
HA-S: J10: No changes
   J20: White colonies
   J31: Small cloud colonies, skin layer
Os-G Pb: J10: Skin layer (A only and D without Pb)
   J20: A Skin layer, B small colonies with brown-white liquid
   J31: A Small cloud colonies, skin layer
      B Large white colonies
Os-G: J10: No changes
   J20: C No changes, D Contamination
   J31: C Upper colonies green, with yellow colonies under D Upper colonies green, with yellow colonies under, brown-red liquid

A second repeat of the experience described in Example IV was performed, but using sucrose and glucose only as carbon sources. The results were as follows:
CTL: No changes
HA-G Pb: J10: White colonies
   J20: (2-3) yellow-brown liquid, white skin layer
HA-G: J10: n/a
   J20: (4) clear-white liquid
HA-S Pb: J10: n/a
   J20: (5-6) clear-white liquid, clear-white colonies, thin skin layer
HA-S: J10: n/a
   J20: (7) idem HA-S
Os-G Pb: J10: n/aJ20: (8) Foggy liquid—Yellow-green skin layer
Os-G: J10: n/aJ20: (10) Brown skin layer

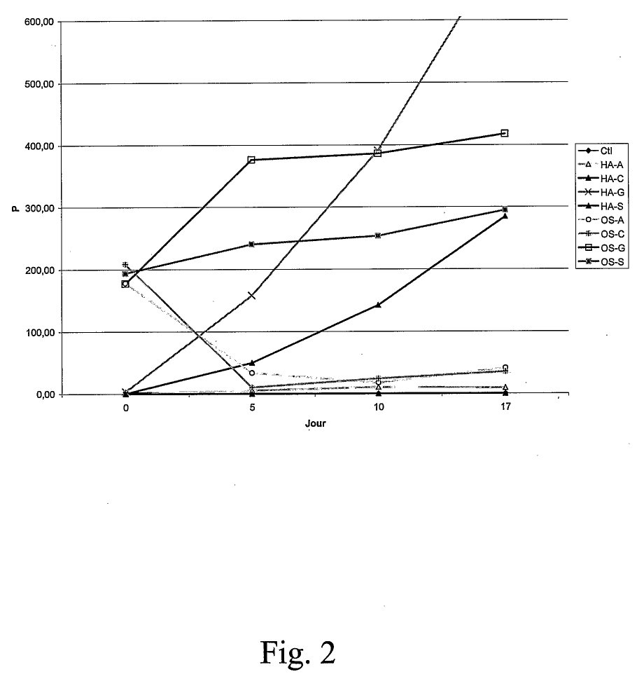

As it can be observed in FIG. 2, when a food compound is treated with a microorganism, such as a Penicillium, the concentration of phosphate rendered available increases significantly.

In conclusion, phosphate availability is increased in the presence of microorganisms, however the degree of P availability is dependant on the source of carbon.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

We claim:

1. A nutritional ingredient for oral administration to humans or animals or both comprising one or more bioavailable mineral nutrients that are absorbable by the digestive-tracts of humans or animals or both, the nutritional ingredient having been treated by at least one type of microorganism so as to render the mineral nutrients bioavailable and absorbable by the digestive tracts of humans or animals or both.

2. A nutritional ingredient as claimed in claim 1, wherein the microorganism is used at a concentration of at least 0.1 mg/l, until the mineral nutrients are rendered bioavailable and absorbable by the digestive tracts of humans or animals or both.

3. The nutritional ingredient as claimed in claim 1, being microbiologically treated by inoculation with at least one type of micro-organism for a period of time sufficient to render the mineral nutrients bioavailable and absorbable by the digestive tracts of animals or humans or both.

4. The nutritional ingredient as claimed in claim 1, wherein said type of micro-organism is selected from the types consisting of a fungus, a bacteria, or a yeast.

5. The nutritional ingredient as claimed in claim 1, wherein said micro-organism is in the form of a spore or an active form.

6. The nutritional ingredient as claimed in claim 4, wherein said fungus is of the genus Penicillium.

7. The nutritional ingredient as claimed in claim 6, wherein said Penicillium is Penicillium bilaii.

8. The nutritional ingredient as claimed in claim 1, wherein said mineral nutrient is selected from the group consisting of phosphorus, calcium, copper, manganese, iron, molybdenum, potassium, zinc, selenium, chromium, fluoride, iodine, magnesium, or salts or derivatives thereof.

9. The nutritional ingredient as claimed in claim 1, wherein said mineral nutrient comprises inorganic mineral elements.

10. The nutritional ingredient as claimed in claim 1, wherein said animal is a fish.

11. The nutritional ingredient as claimed in claim 3, wherein said period of time of treatment by the micro-organism is at least 12 hours.

12. The nutritional ingredient as claimed in claim 1, wherein the mineral nutrients are inherently present in the ingredient.

13. The nutritional ingredient as claimed in claim 1, wherein the mineral nutrients are added to the ingredient.

14. A composition for oral administration to humans or animals or both comprising the nutritional ingredient as claimed in claim 1 together with food ingredients or carriers therefore.

15. A composition as claimed in claim 14, wherein said food ingredient is a food preparation for feeding humans or animals or both.

16. A composition as claimed in claim 14, being microbiologically treated by inoculation with at least one type of micro-organism for a period of time to render the mineral nutrients bioavailable.

17. A composition as claimed in claim 14, wherein said micro-organism is selected from the group consisting of a fungus, a bacteria, or a yeast.

18. A composition as claimed in claim 17, wherein said fungus is of the genus Penicillium.

19. A composition as claimed in claim 18, wherein said Penicillium is Penicillium bilaii.

20. A composition as claimed in claim 14, wherein said micro-organism is in the form of a spore or an active form.

21. A composition as claimed in claim 14, wherein said mineral nutrient is selected from the group consisting of phosphorus, calcium, copper, manganese, iron, molybdenum, potassium, zinc, selenium, chromium, fluoride, iodine, magnesium, salts or derivatives or a combination thereof.

22. A composition as claimed in claim 14, wherein said mineral nutrient comprises inorganic mineral elements.

23. A composition as claimed in claim 14 in the form of a composition selected from the group comprising food supplements, nutritional supplements, foods and animal feeds.

24. A composition as claimed in claim 14, wherein the animal is a fish.

25. A composition as claimed in claim 14, wherein said nutritional ingredient comprises at least 1% of said composition.

26. A composition as claimed in claim 14, in liquid or solid form.

27. A method for treating a nutritional ingredient or composition containing such a nutritional ingredient to render mineral nutrients contained therein bioavailable, comprising subjecting the nutritional ingredient comprising mineral nutrients or a composition containing it, to exposure to at least one type of microorganism to render the mineral nutrients bioavailable and absorbable in the digestive tracts of animals or humans or both.

28. A method as claimed in claim 27, wherein said mineral is selected from the group consisting of phosphorus, calcium, copper, manganese, iron, molybdenum, potassium, zinc, selenium, chromium, fluoride, iodine, magnesium, or salts or derivatives or a combination thereof.

29. A method as claimed in claim 27, wherein said mineral nutrient comprises an inorganic mineral element.

30. A method as claimed in claim 27, wherein said mineral is naturally occurring in said food substrate.

31. A method as claimed in claim 27, wherein the mineral nutrients are added to the nutritional ingredient.

32. A method as claimed in claim 27, wherein said microorganism is selected from the group consisting of a fungus, a bacteria, or a yeast.

33. A method as claimed in claim 32, wherein said fungus is of the genus Penicillium.

34. A method as claimed in claim 27, wherein said Penicillium is Penicillium bilaii.

35. A method as claimed in claim 27, wherein said micro-organism is in the form of a spore or an active form.

36. A method as claimed in claim 27, wherein said animal is a fish.

37. A method as claimed in claim 27, wherein said period of time of treatment by micro-organism is of at least 12 hours.
